(19) United States
(12) Patent Application Publication
(10) Pub. No.: US 2012/0259795 A1
(43) Pub. Date: Oct. 11, 2012

(54) FIXED INCOME INSTRUMENT YIELD SPREAD FUTURES

(76) Inventors: Robert D. Hammond, (US); Richard J. Stevens, (US); Frederick Sturm, Chicago, IL (US); John Labuszewski, Westmont, IL (US)

(21) Appl. No.: 13/082,704

(22) Filed: Apr. 8, 2011

(51) Int. Cl. G06Q 40/00

(52) U.S. Cl. 705/36 R; 705/35

(57) ABSTRACT

A futures contract and method of computing a settlement price thereof are disclosed that enables a market participant to shed or acquire financial exposure in a conventional bond spread, in the form of single futures contract, rather than as a bona fide spread requiring active management of distinct long and short component bond positions, e.g. legs. The notional financial exposure of the futures contract is sized, not in terms of notional amounts/quantities of assets represented in the components of the futures contract's reference spread, but rather in terms of the pecuniary value of one basis point (i.e., 0.01 percent per annum) of the spread between yields to maturity for each of the components of the futures contract's reference spread. Effectively, the spread between the yields is defined inversely, i.e. the price per increment of spread is fixed whereas the quantities/notional amounts of reference bonds and the spread between them are not.

### BACKGROUND

In finance, a yield spread is the difference between the quoted rates of return on two different investments, usually of different credit quality, e.g. the difference in yield between two bonds or bond indexes. It is a compound of yield and spread. The “yield spread of X over Y” is simply the percentage return on investment (“ROI”) from financial instrument X minus the percentage return on investment from financial instrument Y (per annum). The yield spread is a way of comparing any two financial products. In simple terms, it is an indication of the risk premium for investing in one investment product over another.

A bond is a debt investment in which an investor loans a certain amount of money, for a certain amount of time, with a certain interest rate, to a company or country. A government bond is a bond issued by a national government denominated in the country's own currency. Bonds issued by national governments in foreign currencies are normally referred to as sovereign bonds.

The Yield to maturity (“YTM”) or redemption yield of a bond or other fixed-interest/income security, such as gilts, is the internal rate of return (“IRR” or overall interest rate) earned by an investor who buys the bond today at the market price, assuming that the bond will be held until maturity, and that all coupon and principal payments will be made on schedule. Yield to maturity is actually an estimation of future return, as the rate at which coupon payments can be reinvested when received is unknown. It enables investors to compare the merits of different financial instruments. The YTM is often given in terms of Annual Percentage Rate (“A.P.R.”), but more usually market convention is followed: in a number of major markets the convention is to quote yields semi-annually (see compound interest: thus, for example, an annual effective yield of 10.25% would be quoted as 5.00%, because 1.05×1.05=1.1025).

When spreads widen between bonds with different quality ratings it implies that the market is factoring more risk of default on lower grade bonds. For example, if a risk free 10 year Treasury note is currently yielding 5% while junk bonds with the same duration are averaging 7%, the spread between Treasuries and junk bonds is 2%. If that spread widens to 4% (increasing the junk bond yield to 9%), the market is forecasting a greater risk of default which implies a slowing economy. A narrowing of spreads (between bonds of different risk ratings) implies that the market is factoring in less risk (due to an expanding economy). There are several measures of yield spread, including Z-spread and option-adjusted spread.

A trader may trade or otherwise hedge utilizing yield spreads by buying distinct long and short component bond positions, i.e. legs in bonds of the same or varying term/maturity having the same or varying maturity dates. As these would be cash-settled positions, rather than requiring actual delivery of the underliers, the notional, i.e. theoretical, financial exposure of the spread then is sized in terms of notional amounts, i.e. quantities, of assets represented in the components of the futures contract's reference spread, typically expressed in currency units or value.

In holding such positions, however, e.g., in the case of sovereign bond yield spread trades, a trader needs to watch the legs and other indicators (price sensitivity, exchange rate, etc.) closely to ensure the proper balance of the trade that accomplishes the trader's goal. For example, where a trader is attempting to maintain similar interest rate sensitivities between the legs, they may need to adjust the quantities of each leg as the yields rise and fall due to market forces. As the relationship between the bond's internal rate of return and its price may be non-linear, this may be a non-trivial task, especially in a volatile market, requiring effort and time that could be spent elsewhere.

Further, completing these trades in the cash market requires constant re-balancing of legs, i.e. adjustments to the amounts/quantities of the component positions such as by buying and/or selling bonds of the same or different terms/maturities and/or the same or different maturity dates, and monitoring of indicators in furtherance thereof. As an example, consider the US-DE 10-year yield spread wherein the trader anticipates the yield to maturity of the DE Bund will rise relative to the yield to maturity of the US T-Bond. To effect this trade, the trader (1) buys U.S. Treasury notes and (2) sells DE treasury Bunds. If the Bund yield rises, price of the Bund note will fall, therefore the trader will make money because they are short. If the U.S. Treasury yield falls, prices of the treasury note will rise, therefore the trader will make money because they are long. To ensure that the spread will achieve this goal, a trader must constantly monitor three indicators: price sensitivity of treasury leg; price sensitivity of Bund leg; and exchange rate. In addition, profits of such a trade are reduced by entry and exit fees/costs into repo and finance markets, costs associated with adjusting the legs, such as transaction fees, etc.

In addition, if a trader tries to perform this trade in the futures market (as opposed to cash market), the trader would need to post performance bonds at two different clearing houses (assuming the two sovereign bonds are not traded on the same exchange).

Currently a trader can manage yield spread exposures with combinations of cash bonds and/or other over-the-counter (“OTC”) derivatives. Each of these incumbent alternatives poses challenges. For example, combinations of cash bonds require involvement in bond financing repurchase agreement (“RP”) markets, which are notoriously opaque, and in which liquidity is often unreliable. Transacting confers advantages, in the form of premiums, fees, etc., to the dealer banks that stand as the RP markets' dominant liquidity providers, at the expense of end users. Moreover, this avenue of risk management is off-limits to those fiduciary money managers who are bound by statutory or mandated-related strictures on short-selling of securities.

OTC derivatives may be unattractive for many reasons. Apart from a handful of credit default swap (“CDS”) indexes (e.g., the CDX or iTraxx index families), liquidity in the CDS market is patchy. When compared to the liquidity pools that support markets in government securities markets, the associated futures markets, US mortgage backed securities, or conventional interest rate swaps, the liquidity pool that supports CDS is both small and lacking in diversity, with traffic flows dominated by a handful of derivative dealer banks.

Until financial market regulators have finalized terms by which to mandate clearing of CDS by centralized counterparties, the customer has no choice but to enter into International Swaps and Derivatives Association (“ISDA”) master agreements, credit support annexes, and cumbersome collateralization arrangements with one or more sovereign CDS dealer banks.

Within the sovereign yield spread arena, an additional limitation is that sovereign CDS markets face increasingly close regulatory scrutiny, especially in connection with the politically heated debate within the EU over restrictions on short sales of government debt issues and closely related sovereign CDS.

Futures-to-futures spreads may signify a more accessible and tractable risk management tool for yield spread exposures. For instance, at least some fiduciary money managers forbidden from making short sales of debt securities are permitted to hold short open interest in listed futures contracts.

However, as a practical matter, the futures-to-futures toolkit is limited to combinations of sovereign exposures for which usefully deep futures liquidity pools exist: such as CBOT Treasuries, Eurex Bund, Bobl, and Schatz, and NYSE Liffe Gilts.

In theory, the futures-to-futures toolkit extends to credit spread exposures, by way of various interest rate swap futures—e.g., CBOT Interest Rate Swap futures and NYSE Liffe Swapnote® futures for US dollar exposures, and NYSE Liffe [symbol] Swapnote® futures for euro-denominated exposures. Liquidity pools that support these contracts, however, are unsatisfactorily small and shallow for most commercial users.

Within the realm of sovereign yield spread strategies, users of such futures-to-futures spreads are limited by the capital inefficiencies that such spreads entail, by virtue of the required posting of performance bond at multiple clearing houses. Users also must cope with operational inefficiency, in the form of foreign exchange risk exposure, insofar as the most accessible and popular futures-to-futures sovereign spread combinations generate margin pays/collects in different currency denominations. For example, a US-German sovereign credit spread, implemented by establishing a position in CBOT Medium-Term (5-Year) Treasury Note futures against a counter-position in Eurex Bobl futures, requires posting of performance bond at both the CME Clearing House and Eurex Clearing. Moreover, the owner of the spread position must contend with variation margin adjustments that are denominated in US dollars if generated by the CBOT futures component of the position, or in Euros if generated by the Eurex futures component.

### BRIEF DESCRIPTION OF THE DRAWINGS

FIG. 1 shows a table illustrating exemplary reference bonds for use with the disclosed embodiments for hypothetical March 2011, June 2011, and September 2011 delivery months.

FIGS. 2 and 3 depict a flow charts showing exemplary operation of the disclosed embodiments.

FIG. 4 depicts a block diagram of an exemplary system for determining a final settlement price of a futures contract according to one embodiment.

FIG. 5 depicts a block diagram of an exemplary system for maintaining a fixed income instrument yield spread in balance as market conditions change according to one embodiment.

FIG. 6 depicts a block diagram showing an exemplary implementation of the systems of FIGS. 4 and 5.

### DETAILED DESCRIPTION

While the disclosed embodiments will be described in reference to the Chicago Mercantile Exchange (“CME”), it will be appreciated that these embodiments are applicable to any Exchange, including those which trade in equities and other securities. To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

Generally, the disclosed embodiments relate to a futures contract, and method of computing a settlement price thereof, that enables a market participant to shed or acquire financial exposure in a conventional bond spread, in the form of single futures contract, rather than as a bona fide spread requiring active management of distinct long and short component bond positions, e.g. legs. The notional financial exposure of the futures contract is sized, not in terms of notional amounts/quantities of assets represented in the components of the futures contract's reference spread, e.g. the value of the bonds held in currency units, but rather in terms of the pecuniary value of one basis point (i.e., 0.01 percent per annum) of the spread between yields to maturity for each of the components of the futures contract's reference spread. Effectively, the spread between the yields is defined inversely, i.e. the price per increment of spread is fixed whereas the notional quantities/amount of reference bonds and the spread between them are not.

Table 1 summarizes exemplary principal features of the proposed contract mechanism. In one embodiment, the computational steps proposed for determining the final settlement price of a Sovereign Yield Spread futures contract according to the disclosed embodiments may hinge upon the difference between the yield associated with the median price value of a first security and the yield associated with the median price value of a second security, where such median price values are computed over the same selected period of time.

TABLE 1
Yield Spread Futures: Contract Design Features

| | |
|---|---|
| Price Quote | Price Basis: Modified International Monetary |
| | Market (“IMM”) Index = 100 + Yield Spread. |
| | Yield Spread = Sold Asset yield minus Bought |
| | Asset yield. |
| Contract Size | 0.01 index points = 1 basis point = a fixed number |
| | of Currency Units |
| Final Settlement | Delivery by cash settlement. Final mark-to-market |
| | to Final Settlement Price. |
| | For any given Sold Asset and Bought Asset pair, |
| | Final Settlement Price = Price Basis evaluated at |
| | Final Settlement Yield Spread. |

A method for determining the final settlement price of a standardized derivative contract, i.e. a single futures contract, having a fixed-income spread transaction embedded therein is also disclosed. The method includes determining a spread between two yields to maturity, where each such yield to maturity may be based upon a set of multiple reference instruments in place of a single reference instrument wherein the influence of outlier values is reduced or otherwise minimized, as will be described.

In one embodiment, the futures contract is a sovereign yield spread (“Sovy”) futures contract, exemplary features of which are summarized in Table 2, wherein the underlying notional reference may be a sovereign bond spread, comprising (i) a notional long position in a set of Reference Bonds issued by “Bought” Nation and a (ii) a notional short position in a set of Reference Bonds issued by “Sold” Nation, where such notional long and short positions are of equal and opposite magnitude, both in terms of their price sensitivity to interest rate changes, i.e. they may be duration weighted, and, in the case where each position is denominated in a different currency, in terms of their price sensitivity to changes in the pertinent foreign exchange rate, i.e. they may be currency weighted.

In one implementation, as will be described, the reference positions include bonds of a specific term/maturity, e.g. 2 year or 10 year, having varying maturity dates based on the contract definition. Alternatively, futures contracts, according to the disclosed embodiments, may be defined to include reference positions in bonds of varying terms/maturities and/or identical or varying maturity dates, and that such definitions are implementation dependent.

Contract terms and conditions may formally define the identities of “Bought” Nation and “Sold” Nation, and define the standards for determination of contract-grade Reference Bonds to be included in the respective sets of Reference Bonds. Table 3 displays “Bought” Nation and “Sold” Nation combinations for various examples. As in the general case, the Sovereign Yield Spread (“Sovy”) futures contract mechanism enables a market participant to shed or acquire financial exposure in a conventional sovereign bond spread, in the form of single futures contract, rather than as a bona fide spread requiring active management of distinct long and short component sovereign bond positions. It will be appreciated, however, that the disclosed embodiments may be applicable to other yield spreads between other fixed-income instruments having valid yields to maturity or internal rates of return, such as between mortgage-backed security yields and treasury yields, between conventional treasury bond yields and treasury inflation protected bond yields, between corporate bond yields and treasury bond yields, or between municipal bond yields and treasury bond yields.

TABLE 2
10-Year Sovereign Yield Spread Futures: Contract Design Features

| | |
|---|---|
| Price Quote | Price Basis: Modified IMM Index = 100 + Yield |
| | Spread. Yield Spread = Sold Nation yield minus |
| | Bought Nation yield. |
| Contract Size | 0.01 index points = 1 basis point (“bp”) = 100 |
| | Currency Units |
| Delivery | Nearest 4 months in March Quarterly cycle |
| Months | |
| Last Trading | 3rd London-NY-TARGET business day before 10th |
| Day | day of Delivery Month. Trading in expiring contracts |
| | ceases at 3:02 pm London time on Last |
| | Trading Day. |
| Final Settlement | Delivery by cash settlement. Final mark-to-market to |
| | Final Settlement Price. |
| | For any given Sold Nation and Bought Nation pair, |
| | Final Settlement Price = Price Basis evaluated at Final |
| | Settlement Yield Spread. |

TABLE 3
10-Year Sovereign Yield Spread Futures: “Bought” Nation, “Sold”
Nation, and Currency Unit

| Bought | Sold Nation: | | | | |
|---|---|---|---|---|---|
| Nation: | UK | De | Fr | It | Nd |
| US | £ | [symbol] | [symbol] | [symbol] | [symbol] |
| UK | | £ | £ | £ | £ |
| De | | | [symbol] | [symbol] | [symbol] |

Notional “Bought” and notional “Sold” positions are “duration-weighted” and “currency-weighted” in the sense that the contract design, i.e. the fixed monetary value of the spread increments, enforces their equality, in terms of both notional price sensitivity to interest rate movements and profit/loss sensitivity to fluctuations in the pertinent rate of currency exchange, as was described above.

The disclosed embodiments relate to a cash-settled, as opposed to physically delivered, futures contract for which the final settlement price is determined on the basis of price evaluations provided by a reputable third-party, such as a Nationally Recognized Statistical Rating Organization or fixed-income securities price evaluation service. In alternative embodiments, the disclosed contracts could be physically delivered, however it must be recognized that some of the markets at issue for sovereign yield spread trades are not liquid (don't have many participants willing to take delivery).

For each Sovy futures contract, in one embodiment, the price may be quoted on the basis of a modified International Monetary Market (“IMM”) Index:

Price=100+Yield Spread

or,

Price=100+“sold” nation yield−“bought” nation yield

Where the Yield Spread is the difference in “Sold” Nation yield minus “Bought” Nation yield that is expected to prevail at contract expiration. This may be computed based on median forward settlement yields to maturity values, or other values reflective of market sentiment and/or expectations. It will be appreciated that there may be numerous methods of determining a fair purchase price for the disclosed futures contract and may be implementation dependent.

As was described above, the notional size of each Sovy futures contract may be defined in terms of the pecuniary value of one basis point (“bp”) of the contract reference yield spread: One basis point of spread equals 100 Currency Units. Contract terms and conditions define the Currency Unit to be either Euro ( [symbol] ) or UK Pound Sterling (£), depending on the identities of the contract's “Bought” Nation and “Sold” Nation. See Table 3. As described above, this inversely defines the spread allowing the notional size to vary, maintaining the defined spread increment value.

Contract prices may be quoted and made in minimum increments of 0.005 contract price points, i.e., ½ of one basis point of contract reference yield spread exposure, equal to 50 Currency Units.

As an example, consider a US-UK Sovy futures contract, which defines US as “Bought” Nation and UK as “Sold” Nation. Suppose the prevailing view among market participants is that UK Reference Bond yields will exceed US Reference Bond yields by 0.13 percent (i.e., 13 basis points) per annum at contract expiration. The contract price would then be expected to trade in the realm of:

100 plus UK yield minus US yield=100+0.13=100.13

Suppose the contract reference yield spread then widens, such that the UK yield is expected to be 25 basis points above the US yield. The contract price would then rise to:

100 plus UK yield minus US yield=100+0.25=100.25

If these values are assumed to represent successive daily settlement prices, then a long position holder would collect, and a short position holder would pay, variation margin of £1,200 per contract (equal to 12 basis points at £100 per basis point).

In similar fashion, consider a UK-De Sovy futures contract, which defines UK as “Bought” Nation and Germany as “Sold” Nation. If the consensus among market practitioners is that German Reference Bond yields will trade below UK Reference Bond yields by 6.33 percent per annum at contract expiry, then the UK-De contract price would be expected to trade around:

100 plus Germany yield minus UK yield=100+(−6.33)=93.67

If the yield spread foreseen at contract expiration then moves such that the expected German yield drops a further −4.5 basis points relative to the expected UK yield, contract price should fall to:

100 plus Germany yield minus UK yield=100+(−6.375)=93.625

A long position holder would pay, and a short position holder would collect, variation margin of [symbol] 450 per contract, equal to −4.5 basis points at [symbol] 100 per basis point.

Sovy futures may be listed for delivery in March Quarterly months. For any given delivery month, Last Trading Day may be the third EU/London/New York business day preceding that month's 10th day. Trading in an expiring contract may cease at 3:02 pm GMT (generally 9:02 am Chicago time) on Last Trading Day.

At contract expiration, Sovy futures would deliver by cash settlement, by final mark to market to a Final Settlement Price, described in more detail below. For each expiring Sovy futures contract, Final Settlement Price would be determined by the Exchange as:

100

plus the Median of Sold Nation Reference Bond yields

minus the Median of Bought Nation Reference Bond yields

That is, for each sovereignty entailed in the contract notional reference, either as “Long” Nation or as “Short” Nation, the representative yield would be the median value among yields to maturity on each of that sovereignty's Reference Bonds, as defined below.

Utilizing a median value, as opposed to a mean value, to determine yield spread value lowers susceptibility to manipulation by market participants, i.e. bidding up the price of a single bond issue can influence (“pull”) the mean in either direction. However, the median is much harder to manipulate, i.e. a trader would need to bid up the price of at least half of the bond issues. It will be appreciated that any function which minimizes the influence of outlier values may be used to determine the yields, including weighted average, trimmed average, etc.

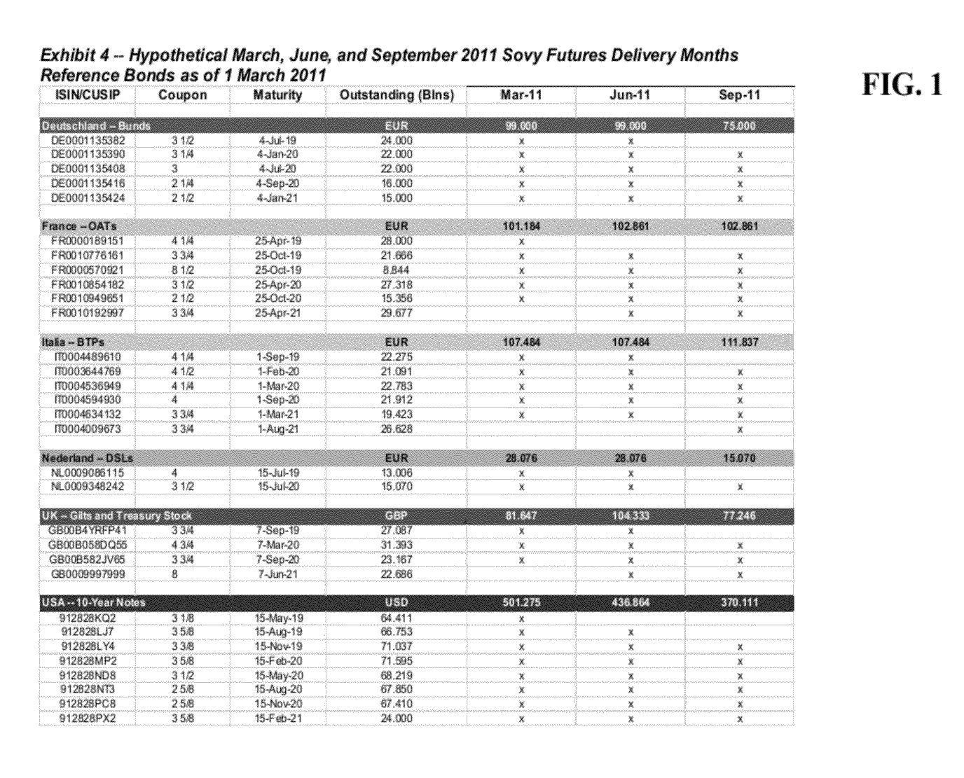

As described above, for each sovereignty entailed in the contract notional reference, either as “Long” Nation or as “Short” Nation, the representative yield would be the median value among yields to maturity on each of that sovereignty's Reference Bonds. In one embodiment for 10 year bonds, the set of Reference Bonds of a particular sovereignty may be defined to be one or more of those standard fixed principal/fixed coupon bonds having remaining term to maturity between 8 years 1 month and 10 years from the contract delivery month, as follows:
De Bunds
Fr OATs
It BTPs
Nd DSLs
UK Conventional Treasury Stock and Treasury Gilts
US Fixed principal notes, semiannual coupons, term to maturity at issue=10 years
8 years 1 month≦Remaining Term to Maturity≦10 years
   For example, Reference Bonds for Sovy futures for a hypothetical March 2011 delivery would be required to mature between 1 Apr. 2019 and 31 Mar. 2021, inclusive. FIG. 1 illustrates for hypothetical March 2011, June 2011, and September 2011 delivery months.

In an alternative embodiment for 2 year bonds, the Reference Bonds of a particular sovereignty may be defined to be one or more of those standard fixed principal/fixed coupon bonds having a remaining term to maturity within the 13 month interval centered on the futures contract expiration month. It will be appreciated that a bond included within the set of Reference Bonds may be selected, or alternatively, the set of Reference bonds, may be defined based on market sentiment as to those bonds whose value most closely represent the overall mark value of the contract as defined by the contract criteria for “contract-grade” bond/assets as may appear in, for example, an Exchange rulebook, and may include one or more bonds. It will be further appreciated that to minimize the influence of any one bond on the value of the futures contract at settlement and mitigate market manipulation, the more bonds that may be included in the set of Reference Bonds, the better.

To effect delivery by cash settlement, the Exchange may designate an approved price data source, such as a Nationally Recognized Statistical Rating Organization or other reputable third-party fixed-income securities pricing service. On the Last Day of Trading in expiring Sovy futures for a given delivery month, the Exchange would obtain from the approved price data source a price evaluation and corresponding yield to maturity, for standard spot settlement. In the embodiment at hand, the Exchange would obtain such price evaluations and corresponding yields to maturity for each Reference Bond, as determined by the approved price data source between 3 pm and 3:02 pm London time.

The disclosed futures contract does not require that the trader hold the legs of the spread in balance because the pricing mechanism is by reference to the median spread yields of the underlying legs. Therefore a trader does not actually hold positions in the underlying legs.

Other systems may exist for allocating portfolio assets, such as in an emerging market, where the portfolio initially includes substantially all fixed income securities or substantially all equities. For example, in these systems a yield spread may be periodically determined between a first fixed income instrument and a second fixed income instrument and a mean spread may be determined based on the determined yield spread over a selected period of time. A band above and below the mean spread may be defined over the selected period of time, where the band has an upper limit above the mean spread and a lower limit below the mean spread. Fixed income securities, in the investment portfolio, may then be switched for equities when a current determined yield spread exceeds the upper limit of the band. Similarly, equities, in the portfolio, may then be switched for fixed income securities when the current determined yield spread falls below the lower limit of the band.

While the disclosed embodiments may appear similar to such a system, the disclosed embodiments relate to a method for determining the final settlement price of a standardized derivative contract, traded on an organized market, which method comprises steps for determining a spread between two yields to maturity, which, contrary to the above referenced system, does not result in a determination of asset allocation in an investment portfolio. Further, the disclosed embodiments, as discussed above, utilize the median, or other computation which minimizes the influence of outlier values, rather than the mean, as the measure of location of the distribution of observed data values “over [the] selected period of time,” thereby, as discussed above, minimizing the overall susceptibility to market manipulation. In addition, the disclosed embodiments apply the measure of location separately to each leg of the spread—specifically, to the distribution of security price values observed for each leg—and not to the distribution of yield spread values. For each leg of the spread, the median price level then determines the corresponding yield level. The yield spread is then computed as the difference between these two yield levels, so derived.

While the disclosed embodiments may relay on on-the-run sovereign bonds, such as Bund or Gilt issue, these too may be susceptible to influence by a market participant by bidding up the bond price at the hour that a pricing service is making its price determination. By using the median of multiple issue bonds, this risk is mitigated. Further, weighted average of yields, such as treasury note yields, weighted on the amount of the issue that is outstanding, may also be used. However, as this is still an average value, it still susceptible to influence by outliers.

Further, the system described above narrowly specifies a yield spread between two fixed-income instruments, one representing each leg of the yield spread whereas the disclosed embodiments are more general. In particular, for either leg of the yield spread at hand, the disclosed embodiments prescribe using one or preferably multiple securities with remaining terms to maturity within a specified range. For each such security, the disclosed method calls for computation of a yield to maturity associated with said security's median price value over a selected period of time, as described above. The yield level associated with said leg of the yield spread is then determined as the median value of yields to maturity of the securities associated with that leg of the spread.

The disclosed Yield Spread futures mechanism, exemplary parameters of which are summarized in Table 4, may offer an easy, clear, safe, and efficient means for modulating yield exposures, in several ways. For example, trading Cost Efficiencies may be achieved because the contract design embeds a fixed-income spread into one contract, there is no need to manage and, if necessary, adjust holdings of the two assets, bought and sold, comprised within the contract's notional spread. Once the futures user has established their position, the contract structure automatically holds the notional legs of the contract's sovereign yield spread exposure in balance as they are not fixed by the contracts design but instead fluctuate to maintain the defined spread increment value. Thus, the futures position holder saves time that they would otherwise spend in monitoring the balance between the spread's bought and sold. They also saves transaction fees that they would otherwise incur by way of mid-course position adjustments to preserve that balance—either to compensate for dislocations in interest rate sensitivity between spread components, or to control the position's exposure to shifts in the pertinent foreign exchange rate.

Capital efficiencies may be achieved because the contract user will need to post performance bond with, at most, only one clearing house rather than two.

Exchange fee efficiencies may be achieved because, for any Yield Spread futures contract, there is only one exchange fee and one clearing house fee per lot traded. By contrast, multiple fees would be required to implement the contract's underlying reference asset spread via futures-to-futures spreads.

Regulatory acceptability may be achieved because the proposed Yield Spread futures would be transparently and competitively traded on a regulated Designated Contract Market, with a transparent daily mark to market, with a Designated Clearing Organization as the central counterparty, with expiration by cash settlement rather than physical delivery of long and short amounts of contract-grade assets, and with stringently enforced Large Trader Reporting requirements. This combination of features is naturally appealing to financial market regulators.

A robust design may be achieved because, particular to the Sovereign Yield Spread futures embodiment, the Final Settlement Price mechanism is based on baskets of Reference Bonds rather than single bond issues. This should serve to promote contract expirations that are correspondingly less vulnerable to crowding, congestion, or manipulation, insofar as any market participant seeking to exert such influence upon a contract expiration would be required to manipulate the prices of multiple Reference Bond issues, not merely a single bond issue.

Appendices A and B show exemplary drafts of contract terms and conditions for, respectively, 2-Year and 10-Year Sovereign Yield Spread Futures, as such contract terms and conditions might be entered into the CME Rulebook or, more generally, the rules and regulations of any designated contract market or futures exchange

TABLE 4
CME Sovereign Yield Spread Futures

| Contract | Difference, at termination of trading, between yield to maturity on | | | | | |
|---|---|---|---|---|---|---|
| Reference | government bonds issued by one sovereignty (“Nation A”) and yield | | | | | |
| | to maturity on government bonds issued by a second sovereignty | | | | | |
| | (“Nation B”). | | | | | |
| Price Basis | Price Index ~ 100 + Yield Spread | | | | | |
| | Yield Spread = Nation A yield minus Nation B yield. | | | | | |
| | Examples - | | | | | |
| | Yield Spread = 13 bps per annum □ Price Index = 100.1300 | | | | | |
| | Yield Spread = −633 bps per annum □ Price Index = 93.6700 | | | | | |
| Contract Grade | Government bonds paying fixed semi-annual or annual interest. | | | | | |
| | Remaining term to maturity from futures contract delivery month— | | | | | |
| | 10-Year Futures: 8 years to 10 years | | | | | |
| | 2-Year Futures: 1 year 6 months to 2 years 6 months | | | | | |
| Contract Size | 10-Year Futures: 0.01 index points = 1 bp = 100 Currency Units | | | | | |
| | 2-Year Futures: 0.01 index points = 1 bp = 50 Currency Units | | | | | |
| | Currency Units | | | | | |
| | Nation A: | UK | De | Fr | It | Nd |
| | Nation B: | | | | | |
| | US | £ | [symbol] | [symbol] | [symbol] | [symbol] |
| | UK | | £ | £ | £ | £ |
| | De | | | [symbol] | [symbol] | [symbol] |

| | |
|---|---|
| Minimum Price | 10-Year Futures: 0.005 index points = 0.5 bps = 50 Currency Units |
| Increments | 2-Year Futures: 0.005 index points = 0.5 bps = 25 Currency Units |
| Delivery | Four nearest months in March-quarterly cycle (Mar, Jun, Sep, Dec) |
| Months | |
| Last Trading | 3rd London-NY-TARGET business day before 10th day of delivery |
| Day | month. |
| | Trading in expiring contracts ceases at 3:02 pm London time. |
| Delivery | Cash settlement by mark-to-market to Final Settlement Price on Last |
| Method | Trading Day. |
| Final Settlement | 100 |
| Price | plus |
| | median of Nation A contract grade bond yields |
| | minus |
| | median of Nation B contract grade bond yields |
| | All contract grade bond yields are as of 3:02 pm London time, and are |
| | furnished to Exchange by third-party price evaluation service |
| | designated as Exchange's approved price data provider. |
| Trading | Globex: 17:30-16:00, US Central Time, Sunday-Friday |
| Platform and | |
| Hours | |
| Block Minimum | 100 contracts |
| Reportable | Reportable position threshold = 25 contracts |
| Positions and | Position accountability threshold = 10,000 contracts |
| Accountability | |

To exemplify the working of a Yield Spread futures contract as disclosed herein, consider a hypothetical contract for delivery in December 2010, which references the spread between a UK gilt and a German Bund, both with approximately 10 years to maturity.

The contract reference yield spread is defined by contract terms and conditions to be the German Bund yield minus the UK gilt yield, for spot settlement on the last day of trading and expiration in the contract. For this example, assume the last day of trading and expiration is Wednesday, 7 Dec. 2010.

The contract price is defined in terms of points and is quoted as 100 points plus the contract reference yield spread. Each price point signifies an increment of one percent per annum of the contract reference yield spread. A contract price of 101.00, for instance, could be interpreted to suggest that the buyer and seller of the contract share the expectation that the spread between the 10-year German Bund yield minus the 10-year UK gilt yield should be one percent per annum at contract expiry.

Accordingly, each 1/100th of one price point, i.e., 0.01 price points, signifies an increment of one basis point per annum of the contract reference yield spread. The futures contract is defined such that each increment of 0.01 price points (equivalently, one interest rate basis point) is equal to £100.

The futures contract effects delivery by cash settlement, with reference to a final settlement price determined by the Exchange on the basis of conditions in the markets for 10-year UK gilts and 10-year German Bunds at the time the contract ceases trading.

Prior to Contract Expiration

Let Day 1 be some Exchange business day preceding futures contract expiration. Suppose a market participant purchases such a contract at a price of 99.425. The contract price indicates that the purchaser and the market participant who sold the contract to her share the expectation that the yield spread at contract expiration will be around −0.575 percent per annum, i.e., that the 10-year UK gilt yield will reside 57.5 basis points below the 10-year German Bund yield.

Let Day 2 be the next following Exchange business day, also assumed to precede the last day of trading and expiration in the futures contract. Suppose the market participant sells the contract at a price of 99.390, i.e., at a loss of −0.035 points (equal to 99.390 minus 99.425). This loss will be realized at the close of the business day, at which time the market participant will be obliged to pay variation margin of £350 (equal to −0.035×£100 per 0.01) to the CME Clearing House, via her account with her futures commission merchant (assumed here to be a CME Clearing Member firm).

At Contract Expiration

Now suppose that instead of selling the futures contract she purchased on Day 1, the market participant carries the contract to expiration.

The contract will expire by cash settlement with reference to a final settlement price determined on the basis of UK and German government bond market conditions around 3 pm GMT on Wednesday, 7 Dec. 2010. For this example, assume the final settlement price is determined by the Exchange as follows—

The Exchange obtains from its designated price data provider (a reputable third-party price evaluation service and/or Nationally Recognized Statistical Rating Service) market yields for all contract-grade sovereign bond issues pertinent to the December 2010 futures delivery month. Contract-grade sovereign bonds are those that meet the criteria, specified in the contract terms and conditions, to serve as reference bonds for entering into determination of the contract final settlement price. These criteria admit the ten bond issues shown in the following exhibit.

TABLE 5
Hypothetical Dec2010 UK-De Sovereign Yield Spread Futures
Expiration Wednesday, 7 Dec. 2010, 3:02 pm London Time

| UK~Bought Nation | | | Yield | De~Sold Nation | | Yield |
|---|---|---|---|---|---|---|
| 4½ | 7-Mar-19 | Gilt | 3.219565 | 3¾ | 4-Jan-19 | 2.719677 |
| 3¾ | 7-Sep-19 | Gilt | 3.352914 | 3½ | 4-Jul-19 | 2.807553 |
| 4¾ | 7-Mar-20 | Stock | 3.438874 | 2¼ | 4-Sep-20 | 2.871561 |
| 3¾ | 7-Sep-20 | Gilt | 3.562808 | 3¼ | 4-Jan-20 | 2.882223 |
| | | | | 3 | 4-Jul-20 | 2.923315 |

| | | |
|---|---|---|
| Median Yields: | 3.395894 | 2.871561 |

The four contract-grade UK gilt issues, and their respective yields to maturity for standard spot settlement (T+1 in the UK gilts market), appear in the four left-most columns. The five contract grade German Bund issues, and their respective yields to maturity for standard spot settlement (T+3 in the German government bond market). appear in the three right-most columns.

For each sovereign jurisdiction, the Exchange computes the median value of yields to maturity on contract-grade bonds. These median values appear in the bottom row of the exhibit.

The Exchange then evaluates the contract price using these median yield values—

$$\begin{matrix}Final Settlement Price = 100 plus Sold Nation ( De ) Median \\ Yield minus Bought Nation ( UK ) \\ Median Yield \\ = 100 plus 2.871561 minus 3.395894 \\ = 99.4757\end{matrix} \qquad$$

The contract is then extinguished by a last mark-to-market with reference to this final settlement price.

Thus, between Day 1 (on which the market participant purchased her contract) and the day of contract final settlement, the price has risen +0.0507 points (equal to 99.4757 minus 99.425). It follows that the net value of all intervening daily marks-to-market is +0.0507, and that the net value of the corresponding variation margin pays and collects is a gain of £507.

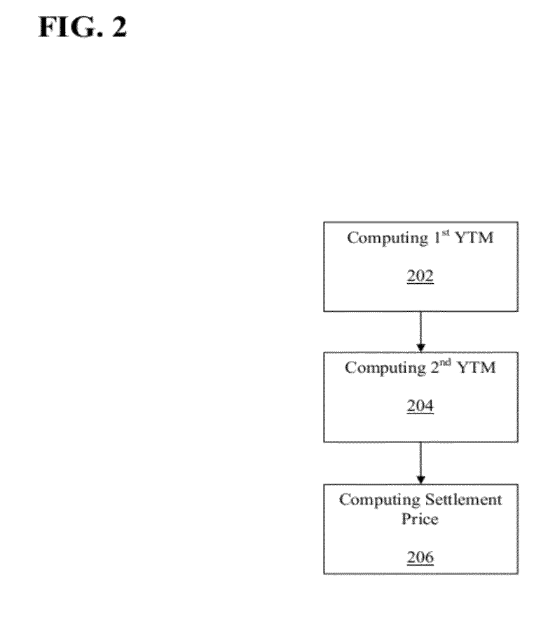

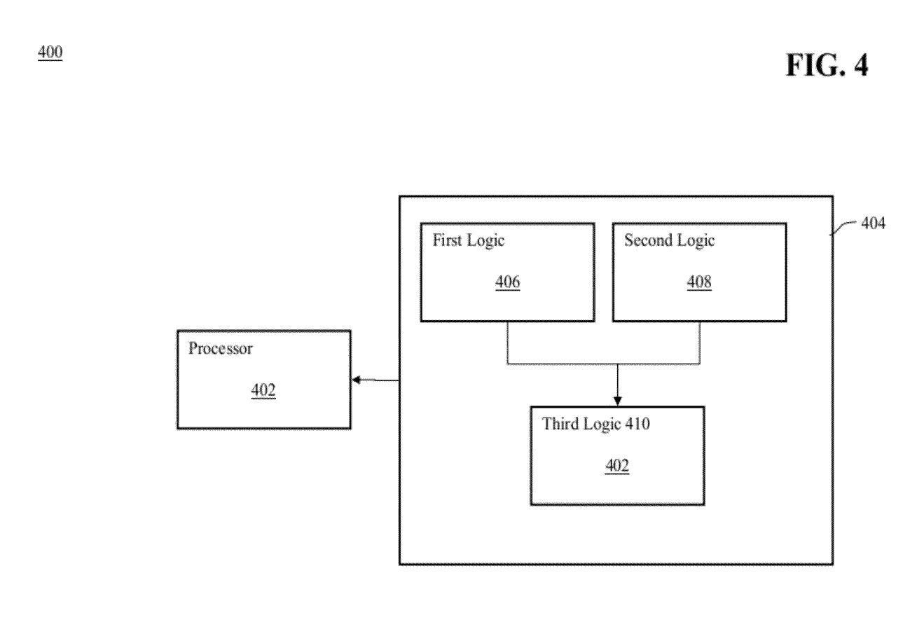

Referring to FIG. 2, there is shown a flow chart depicting exemplary operation of the disclosed embodiments which may be implemented on a computer such as the computer 600 described in more detail below with respect to FIG. 4. In particular, FIG. 2 shows a computer implemented method for determining a final settlement price of a futures contract the underlier of which is a reference spread between a first reference position in a first set of fixed income instruments and a second reference position in a second set of fixed income instruments, the second reference position being equal but opposite in magnitude to the first reference position. In one embodiment, the first reference position comprises a notional long position in the first set of fixed income instruments and the second reference position comprises a notional short position in the second set of fixed income instruments. The reference spread may be characterized by a magnitude specified as a number of incremental units, such as basis points or fractions thereof, between a representative yield to maturity of the first set of fixed income instruments and a representative yield to maturity of the second set of fixed income instrument. The contract may further define a fixed value of each incremental unit, e.g. each basis point, such as the pecuniary value of one basis point of the spread between the representative yields to maturity of first and second sets of financial instruments where one basis point may be equivalent to 100 currency units.

In one embodiment, each of the first set of fixed income instruments comprise a bond issued by a first sovereignty and characterized by a maturity, such as 2 year or 10 year, and each of the second set of fixed income instruments comprise a bond issued by a second sovereignty different from the first sovereignty and characterized by the same maturity, e.g. 2 year or 10 year. In alternative embodiments, each of the first set of fixed income instruments comprise a mortgage backed security and each of the second set of fixed income instruments comprise a treasury bond or each of the first set of fixed income instruments comprise a long term conventional treasury bond and each of the second set of fixed income instruments comprise a treasury inflation protected bond.

In one embodiment, the price of the contract may have been previously computed based on the difference between the expected yield at maturity of the first set of fixed instruments and the expected yield at maturity of the second set of fixed instruments.

In one embodiment, the second reference position is equal but opposite in magnitude to the first reference position with respect to price sensitivity to changes in interest rate. For example, the first and second reference positions may be duration weighted. Alternatively, or in addition thereto, the second reference position is equal but opposite in magnitude to the first reference position with respect to price sensitivity to changes in an exchange rate. For example, the first and second reference positions may be currency weighted.

The operation includes computing, by a first processor, a first representative yield to maturity of a first subset of the first set of fixed income instruments, each fixed income instrument of the first subset being characterized by a maturity date occurring within a first date range, the influence on the first representative yield to maturity of those fixed income instruments of the first subset characterized as having an outlier yield to maturity being minimized thereby (block 202). The operation further includes computing, by a second processor, a second representative yield to maturity of a second subset of the second set of fixed income instruments, each fixed income instrument of the second subset being characterized by a maturity date occurring within a second date range, the influence on the second representative yield to maturity of those fixed income instruments of the second plurality characterized as having an outlier yield to maturity being minimized thereby (block 204). In one embodiment, the first and second date ranges comprise maturity dates between 97 and 120 months from settlement of the contract. In an alternative embodiment, the first and second date ranges comprise maturity dates occurring with a 13 month interval centered on an expiration date of the contract.

In one embodiment, the computing of the first representative yield to maturity further comprises computing a median yield to maturity for the first subset, and the computing of the second representative yield to maturity further comprises computing a median yield to maturity for the second subset. It will be appreciated that other functions such as weighted or trimmed average may also be used.

The operation further includes computing, by a third processor coupled with the first and second processors, the final settlement price as the difference between the first and second representative yields to maturity, irrespective of the quantity, e.g. notional amounts, of first and second fixed income instruments in the first and second sets needed for the first and second reference positions respectively, to maintain the fixed value of each incremental unit of the reference spread (block 206). Herein, the phrase “coupled with” is defined to mean directly connected to or indirectly connected through one or more intermediate components. Such intermediate components may include both hardware and software based components.

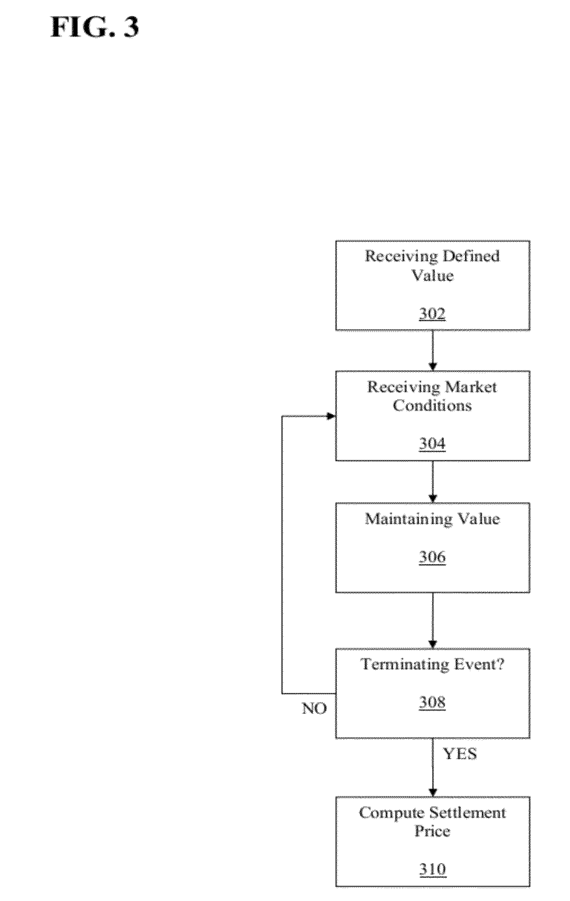

Referring to FIG. 3, there is shown a flow chart depicting exemplary operation of the disclosed embodiments which may be implemented on a computer such as the computer 600 described in more detail below with respect to FIG. 4. In particular, FIG. 3 shows a computer implemented method of maintaining a fixed income instrument yield spread in balance as market conditions change until an occurrence of a terminating event. The operation includes receiving, from a user via first interface, a defined pecuniary value of one basis point of a reference yield spread between representative yields of a first reference position in a set of first fixed income instruments and a second reference position in a set of second fixed income instruments of equal but opposite magnitude to the first reference position (block 302). In one embodiment, the pecuniary value of one basis point may be defined as 100 currency units. In one embodiment, each of the first set of fixed income instruments comprise a bond issued by a first sovereignty characterized by a maturity, such as 2 year or 10 year, and each of the second set of fixed income instruments comprise a bond issued by a second sovereignty different from the first sovereignty and characterized by the same maturity. In alternative embodiments, each of the first set of fixed income instruments comprise a mortgage backed security and each of the second set plurality of fixed income instruments comprise a treasury bond or each of the first set of fixed income instruments comprise a long term conventional treasury bond and each of the second set of fixed income instruments comprise a treasury inflation protected bond.

In one embodiment, the first reference position may include a notional long position in the first set of fixed income instruments and the second reference position may include a notional short position in the second set of fixed income instruments wherein the second reference position may be equal but opposite in magnitude to the first reference position with respect to price sensitivity to changes in interest rate, i.e. the first and second reference positions may be duration weighted, and/or the second reference position may be equal but opposite in magnitude to the first reference position with respect to price sensitivity to changes in an exchange rate, i.e. the first and second reference positions may be currency weighted.

The operation further includes receiving, via a second interface, data representative of market conditions for the first and second fixed income instruments (block 304), such as changes in one or more pertinent interest rates, and maintaining, automatically by a processor coupled with the first and second interfaces, the pecuniary value by allowing quantities, e.g. notional amounts, of the first and second fixed income instruments of the first and second sets to fluctuate as the market conditions change (block 306).

In one embodiment, the maintaining may further include compensating, automatically by the processor, for dislocations in interest rate sensitivity between the first and second reference positions. Alternatively, or in addition thereto, wherein the first position is characterized by a first currency unit and the second position is characterized by a second currency unit different from the first currency unit, the maintaining may further include compensating, automatically by the processor, for fluctuations in an exchange rate between the first and second currency units.

Further, the quantities, e.g. notional amounts, of the first and second sets may be determined upon the occurrence of the terminating event (block 308) by determining, for a first subset of the first set of fixed income instruments, each fixed income instrument of the first subset being characterized by a maturity date occurring within a first date range and a yield to maturity, and a second subset of the second set of fixed income instruments, each fixed income instrument of the second subset being characterized by a maturity date occurring within second date range and a yield to maturity, a first representative yield to maturity of the first subset and a second representative yield to maturity of the second subset and determining a value of the reference yield spread based on a difference between the first and second representative yields to maturity (block 310).

In one embodiment, the first and second date ranges may include maturity dates between, inclusively, 97 and 120 months from settlement of the contract or, alternatively, the first and second date ranges may include maturity dates occurring with a 13 month interval centered on an expiration date of the contract.

In one embodiment, the first and second representative yields to maturity are determined such that influence of those fixed value instruments of the respective first and second subsets of fixed income instruments having outlier yields to maturity is minimized. For example, the first representative yield to maturity may include a median yield to maturity of the first subset of fixed income instruments and the second representative yield to maturity may include a median yield to maturity of the second subset of fixed income instruments. It will be appreciated that other functions such as weighted or trimmed average may also be used.

In one embodiment, the operation further includes requiring, by the processor, maintenance, by the user, of a performance bond to cover risk of loss of the fixed income instrument yield spread irrespective of the first and second reference positions.

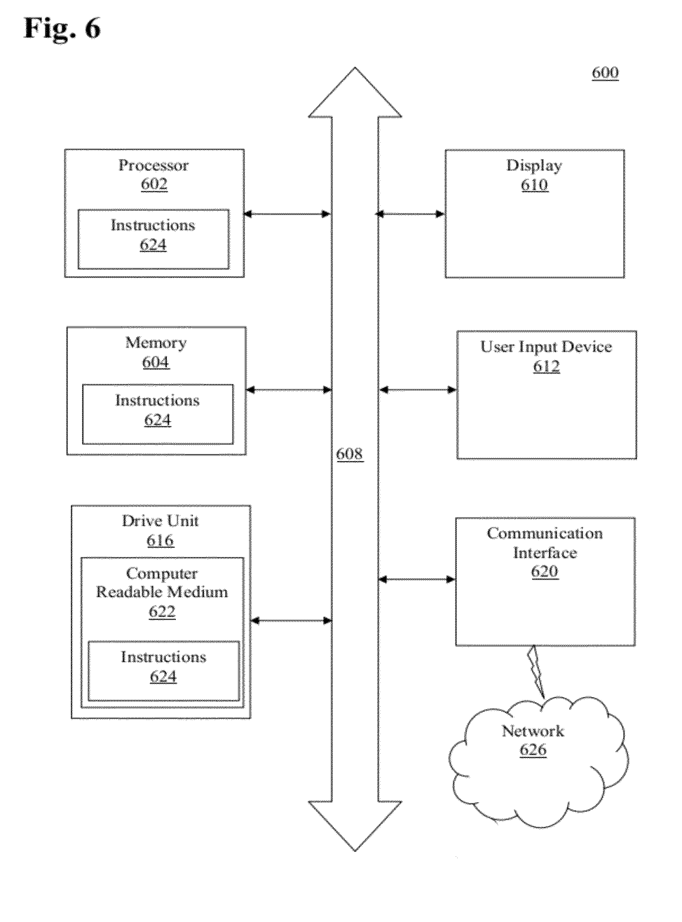

Referring to FIG. 4, there is shown a block diagram of a system 400 for determining a final settlement price of a futures contract the underlier of which is a reference spread between a first reference position in a first set of fixed income instruments and a second reference position in a second set of fixed income instruments. In one embodiment, the system 400 may be implemented as a computer 600 described below with respect to FIG. 6, and includes a processor 402 and memory 404 coupled therewith. In one embodiment, the second reference position may be equal but opposite in magnitude to the first reference position, the reference spread being characterized by a magnitude specified as a number of incremental units, e.g. basis points, between a representative yield to maturity of the first set of fixed income instruments and a representative yield to maturity of the second set of fixed income instrument, the contract further defining a fixed value of each incremental unit, e.g. one basis point to 100 currency units.

The system 400 further includes first logic 406 stored in the memory 404 and executable by the processor 402 to compute a first representative yield to maturity of a first subset of the first set of fixed income instruments, each fixed income instrument of the first subset being characterized by a maturity date occurring within a first date range, the influence on the first representative yield to maturity of those fixed income instruments of the first subset characterized as having an outlier yield to maturity being minimized thereby, and second logic 408 stored in the memory 404 and executable by the processor 402 to compute a second representative yield to maturity of a second subset of the second set of fixed income instruments, each fixed income instrument of the second subset being characterized by a maturity date occurring within a second date range, the influence on the second representative yield to maturity of those fixed income instruments of the second plurality characterized as having an outlier yield to maturity being minimized thereby.

In one embodiment, the first reference position may include a notional long position in the first set of fixed income instruments and the second reference position may include a notional short position in the second set of fixed income instruments. In one embodiment, the second reference position is equal but opposite in magnitude to the first reference position with respect to price sensitivity to changes in interest rate, e.g. the first and second reference positions are duration weighted, and/or with respect to price sensitivity to changes in an exchange rate, e.g. the first and second reference positions are currency weighted.

In one embodiment, each of the first set of fixed income instruments comprise a bond issued by a first sovereignty and characterized by a maturity, e.g. 2 year or 10 year, and each of the second set of fixed income instruments comprise a bond issued by a second sovereignty different from the first sovereignty and characterized by the maturity. In alternative embodiments, each of the first set of fixed income instruments may include a mortgage backed security and each of the second set of fixed income instruments may include a treasury bond, or each of the first set of fixed income instruments may include a long term conventional treasury bond and each of the second set of fixed income instruments may include a treasury inflation protected bond.

In one embodiment, the first and second date ranges may include maturity dates between 97 and 120 months from settlement of the contract. Alternatively, the first and second date ranges may include maturity dates occurring with a 13 month interval centered on an expiration date of the contract.

In one embodiment, the first logic 406 is further executable by the processor 402 to compute the first representative yield to maturity as a median yield to maturity of the first subset, and the second logic is further executable by the processor to compute the second representative yield to maturity as a median yield to maturity of the second subset.

In one embodiment, the price of the contract may have been previously computed based on the difference between the expected yield at maturity of the first set of fixed instruments and the expected yield at maturity of the second set of fixed instruments.

The system 400 further includes third logic 410 stored in the memory 404 and coupled with the first 406 and second logic 408 and executable by the processor 402 to compute the final settlement price as the difference between the first and second representative yields to maturity, irrespective of the quantity, e.g. notional amounts, of first and second fixed income instruments in the first and second sets needed for the first and second reference positions respectively, to maintain the fixed value of each incremental unit of the reference spread.

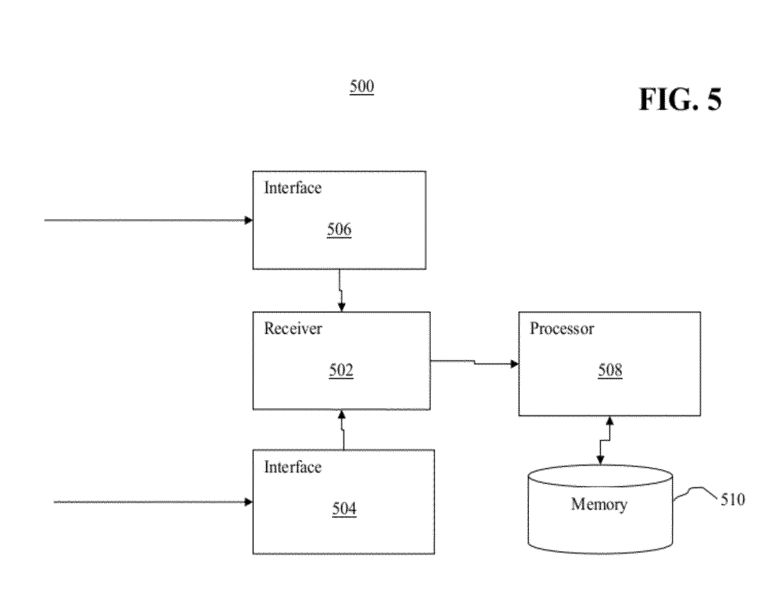

Referring to FIG. 5, there is shown a block diagram of a system 500 for maintaining a fixed income instrument yield spread in balance as market conditions change until an occurrence of a terminating event. In one embodiment, the system 500 may be implemented as a computer 600 described below with respect to FIG. 6, and includes a receiver 502 operative to receive, from a user via first interface 504, such as a network interface, coupled with the receiver, a defined pecuniary value, such as 100 currency units, of one basis point of a reference yield spread between representative yields of a first reference position in a set of first fixed income instruments and a second reference position in a set of second fixed income instruments of equal but opposite magnitude to the first reference position, data representative thereof being stored in a memory 510. In one embodiment, the first reference position comprises a notional long position in the first set of fixed income instruments and the second reference position comprises a notional short position in the second set of fixed income instruments. In one embodiment, the second reference position is equal but opposite in magnitude to the first reference position with respect to price sensitivity to changes in interest rate, e.g. the first and second reference positions are duration weighted, and/or with respect to price sensitivity to changes in an exchange rate, e.g. the first and second reference positions are currency weighted.

In one embodiment, the first set of fixed income instruments comprise a bond issued by a first sovereignty and characterized by a maturity, such as 2 year or 10 year, and each of the second set of fixed income instruments comprise a bond issued by a second sovereignty different from the first sovereignty and characterized by the maturity. In alternative embodiments, each of the first set of fixed income instruments may include a mortgage backed security and each of the second set plurality of fixed income instruments may include a treasury bond, or each of the first set of fixed income instruments may include a long term conventional treasury bond and each of the second set of fixed income instruments may include a treasury inflation protected bond.

The receiver 502 is further operative to receive, via a second interface 606, such as a network interface, coupled with the receiver, data representative of market conditions, such as from an electronic market data service (not shown), for the first and second fixed income instruments, such as changes to one or more pertinent interest rates.

The system 500 further includes a processor 508 coupled with the receiver 502 and the memory 510 and operative to maintain, automatically, the defined pecuniary value by allowing quantities, e.g. notional amounts, of the first and second fixed income instruments of the first and second sets to fluctuate as the market conditions change. In one embodiment, the processor 508 is further operative to maintain the defined pecuniary value by compensating, automatically by the processor 508, for dislocations in interest rate sensitivity between the first and second reference positions. Alternatively, or in addition thereto, wherein the first position is characterized by a first currency unit and the second position is characterized by a second currency unit different from the first currency unit, the processor 508 may be further operative to maintain the defined pecuniary value by compensating, automatically by the processor 508, for fluctuations in an exchange rate between the first and second currency units.

In one embodiment, the processor 508 further requires, or otherwise generates a request for, maintenance, by the user, of a performance bond to cover risk of loss of the fixed income instrument yield spread irrespective of the first and second reference positions.

Wherein the quantities, e.g. notional amounts, of the first and second sets are determined by the processor 508 upon the occurrence of the terminating event by determining, for a first subset of the first set of fixed income instruments, each fixed income instrument of the first subset being characterized by a maturity date occurring within a first date range and a yield to maturity, and a second subset of the second set of fixed income instruments, each fixed income instrument of the second subset being characterized by a maturity date occurring within second date range and a yield to maturity, a first representative yield to maturity of the first subset and a second representative yield to maturity of the second subset and determining a value of the reference yield spread based on a difference between the first and second representative yields to maturity.

In one embodiment, the first and second date ranges include maturity dates between 97 and 120 months, inclusively, from settlement of the contract. Alternatively, the first and second date ranges may include maturity dates occurring with a 13 month interval centered on an expiration date of the contract.

In one embodiment, the processor 508 is further operative to determine the first and second representative yields to maturity such that influence of those fixed value instruments of the respective first and second subsets of fixed income instruments having outlier yields to maturity is minimized, such as by computing the first representative yield to maturity as a median yield to maturity of the first subset of fixed income instruments and the second representative yield to maturity as a median yield to maturity of the second subset of fixed income instruments. It will be appreciated that other functions, such as weighted average or trimmed average may also be used.

Referring to FIG. 6, an illustrative embodiment of a general computer system 600 is shown. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices. Any of the components discussed above may be a computer system 600 or a component in the computer system 600. The computer system 600 may implement a match engine, margin processing or clearing function on behalf of an exchange, such as the Chicago Mercantile Exchange, of which the disclosed embodiments are a component thereof.

In a networked deployment, the computer system 600 may operate in the capacity of a server or as a client user computer in a client-server user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. The processor 602 may be a component in a variety of systems. For example, the processor 602 may be part of a standard personal computer or a workstation. The processor 602 may be one or more general processors, digital signal processors, application specific integrated circuits, field programmable gate arrays, servers, networks, digital circuits, analog circuits, combinations thereof, or other now known or later developed devices for analyzing and processing data. The processor 602 may implement a software program, such as code generated manually (i.e., programmed).

The computer system 600 may include a memory 604 that can communicate via a bus 608. The memory 604 may be a main memory, a static memory, or a dynamic memory. The memory 604 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 604 includes a cache or random access memory for the processor 602. In alternative embodiments, the memory 604 is separate from the processor 602, such as a cache memory of a processor, the system memory, or other memory. The memory 604 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts or tasks illustrated in the figures or described herein may be performed by the programmed processor 602 executing the instructions stored in the memory 604. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 600 may further include a display unit 614, such as a liquid crystal display (LCD), an organic light emitting diode (OLED), a flat panel display, a solid state display, a cathode ray tube (CRT), a projector, a printer or other now known or later developed display device for outputting determined information. The display 614 may act as an interface for the user to see the functioning of the processor 602, or specifically as an interface with the software stored in the memory 604 or in the drive unit 606.

Additionally, the computer system 600 may include an input device 616 configured to allow a user to interact with any of the components of system 600. The input device 616 may be a number pad, a keyboard, or a cursor control device, such as a mouse, or a joystick, touch screen display, remote control or any other device operative to interact with the system 600.

In a particular embodiment, as depicted in FIG. 6, the computer system 600 may also include a disk or optical drive unit 606. The disk drive unit 606 may include a computer-readable medium 610 in which one or more sets of instructions 612, e.g. software, can be embedded. Further, the instructions 612 may embody one or more of the methods or logic as described herein. In a particular embodiment, the instructions 612 may reside completely, or at least partially, within the memory 604 and/or within the processor 602 during execution by the computer system 600. The memory 604 and the processor 602 also may include computer-readable media as discussed above.

The present disclosure contemplates a computer-readable medium that includes instructions 612 or receives and executes instructions 612 responsive to a propagated signal, so that a device connected to a network 620 can communicate voice, video, audio, images or any other data over the network 620. Further, the instructions 612 may be transmitted or received over the network 620 via a communication port 618. The communication port 618 may be a part of the processor 602 or may be a separate component. The communication port 618 may be created in software or may be a physical connection in hardware. The communication port 618 is configured to connect with a network 620, external media, the display 614, or any other components in system 600, or combinations thereof. The connection with the network 620 may be a physical connection, such as a wired Ethernet connection or may be established wirelessly as discussed below. Likewise, the additional connections with other components of the system 600 may be physical connections or may be established wirelessly.

The network 620 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

We claim:

1. A computer implemented method for determining a final settlement price of a futures contract the underlier of which is a reference spread between a first reference position in a first set of fixed income instruments and a second reference position in a second set of fixed income instruments, the second reference position being equal but opposite in magnitude to the first reference position, the reference spread being characterized by a magnitude specified as a number of incremental units between a representative yield to maturity of the first set of fixed income instruments and a representative yield to maturity of the second set of fixed income instrument, the contract further defining a fixed value of each incremental unit, the method comprising:
computing, by a first processor, a first representative yield to maturity of a first subset of the first set of fixed income instruments, each fixed income instrument of the first subset being characterized by a maturity date occurring witching a first date range, the influence on the first representative yield to maturity of those fixed income instruments of the first subset characterized as having an outlier yield to maturity being minimized thereby;
computing, by a second processor, a second representative yield to maturity of a second subset of the second set of fixed income instruments, each fixed income instrument of the second subset being characterized by a maturity date occurring within a second date range, the influence on the second representative yield to maturity of those fixed income instruments of the second plurality characterized as having an outlier yield to maturity being minimized thereby; and
computing, by a third processor coupled with the first and second processors, the final settlement price as the difference between the first and second representative yields to maturity, irrespective of the quantity of first and second fixed income instruments in the first and second sets needed for the first and second reference positions respectively, to maintain the fixed value of each incremental unit of the reference spread.

2. The computer implemented method of claim 1 wherein the first reference position comprises a notional long position in the first set of fixed income instruments and the second reference position comprises a notional short position in the second set of fixed income instruments.

3. The computer implemented method of claim 1 wherein the computing of the first representative yield to maturity further comprises computing a median yield to maturity for the first subset, and the computing of the second representative yield to maturity further comprises computing a median yield to maturity for the second subset.

4. The computer implemented method of the claim 1 wherein the first and second date ranges comprise maturity dates between 97 and 120 months from settlement of the contract.

5. The computer implemented method of the claim 1 wherein the first and second date ranges comprise maturity dates occurring with a 13 month interval centered on an expiration date of the contract.

6. The computer implemented method of claim 1 wherein the incremental unit is one basis point equivalent to 100 currency units.

7. The computer implemented method of claim 1 wherein each of the first set of fixed income instruments comprise a bond issued by a first sovereignty and characterized by a maturity and each of the second set of fixed income instruments comprise a bond issued by a second sovereignty different from the first sovereignty and characterized by the maturity.

8. The computer implemented method of claim 7 wherein the maturity is one of 2 year or 10 year.

9. The computer implemented method of claim 1 wherein each of the first set of fixed income instruments comprise a mortgage backed security and each of the second set of fixed income instruments comprise a treasury bond.

10. The computer implemented method of claim 1 wherein each of the first set of fixed income instruments comprise a long term conventional treasury bond and each of the second set of fixed income instruments comprise a treasury inflation protected bond.

11. The computer implemented method of claim 1 wherein the price of the contract was previously computed based on the difference between the expected yield at maturity of the first set of fixed instruments and the expected yield at maturity of the second set of fixed instruments.

12. The computer implemented method of claim 1 wherein the second reference position is equal but opposite in magnitude to the first reference position with respect to price sensitivity to changes in interest rate.

13. The computer implemented method of claim 12 wherein the first and second reference positions are duration weighted.

14. The computer implemented method of claim 1 wherein the second reference position is equal but opposite in magnitude to the first reference position with respect to price sensitivity to changes in an exchange rate.

15. The computer implemented method of claim 14 wherein the first and second reference positions are currency weighted.

16. A computer implemented method of maintaining a fixed income instrument yield spread in balance as market conditions change until an occurrence of a terminating event, the method comprising:
receiving, from a user via first interface, a defined pecuniary value of one basis point of a reference yield spread between representative yields of a first reference position in a set of first fixed income instruments and a second reference position in a set of second fixed income instruments of equal but opposite magnitude to the first reference position;
receiving, via a second interface, data representative of market conditions for the first and second fixed income instruments;
maintaining, automatically by a processor coupled with the first and second interfaces, the pecuniary value by allowing quantities of the first and second fixed income instruments of the first and second sets to fluctuate as the market conditions change; and
wherein the quantities of the first and second sets are determined upon the occurrence of the terminating event by determining, for a first subset of the first set of fixed income instruments, each fixed income instrument of the first subset being characterized by a maturity date occurring within a first date range and a yield to maturity, and a second subset of the second set of fixed income instruments, each fixed income instrument of the second subset being characterized by a maturity date occurring within second date range and a yield to maturity, a first representative yield to maturity of the first subset and a second representative yield to maturity of the second subset and deterring a value of the reference yield spread based on a difference between the first and second representative yields to maturity.

17. The computer implemented method of claim 16 wherein the first reference position comprises a notional long position in the first set of fixed income instruments and the second reference position comprises a notional short position in the second set of fixed income instruments.

18. The computer implemented method of claim 16 wherein the pecuniary value of one basis point is defined as 100 currency units.

19. The computer implemented method of the claim 16 wherein the first and second date ranges comprise maturity dates between 97 and 120 months from settlement of the contract.

20. The computer implemented method of the claim 16 wherein the first and second date ranges comprise maturity dates occurring with a 13 month interval centered on an expiration date of the contract.

21. The computer implemented method of claim 16 further comprising determining the first and second representative yields to maturity such that influence of those fixed value instruments of the respective first and second subsets of fixed income instruments having outlier yields to maturity is minimized.

22. The computer implemented method of claim 16 wherein the first representative yield to maturity comprises a median yield to maturity of the first subset of fixed income instruments and the second representative yield to maturity comprises a median yield to maturity of the second subset of fixed income instruments.

23. The computer implemented method of claim 16 wherein each of the first set of fixed income instruments comprise a bond issued by a first sovereignty and characterized by a maturity and each of the second set of fixed income instruments comprise a bond issued by a second sovereignty different from the first sovereignty and characterized by the maturity.

24. The computer implemented method of claim 23 wherein the maturity is one of 2 year or 10 year.

25. The computer implemented method of claim 16 wherein each of the first set of fixed income instruments comprise a mortgage backed security and each of the second set plurality of fixed income instruments comprise a treasury bond.

26. The computer implemented method of claim 16 wherein each of the first set of fixed income instruments comprise a long term conventional treasury bond and each of the second set of fixed income instruments comprise a treasury inflation protected bond.

27. The computer implemented method of claim 16 wherein changes in the market conditions comprises changes in an interest rate.

28. The computer implemented method of claim 16 wherein the maintaining further comprises compensating, automatically by the processor, for dislocations in interest rate sensitivity between the first and second reference positions.

29. The computer implemented method of claim 16 wherein the first position is characterized by a first currency unit and the second position is characterized by a second currency unit different from the first currency unit, the maintaining further comprises compensating, automatically by the processor, for fluctuations in an exchange rate between the first and second currency units.

30. The computer implemented method of claim 16 wherein the second reference position is equal but opposite in magnitude to the first reference position with respect to price sensitivity to changes in interest rate.

31. The computer implemented method of claim 30 wherein the first and second reference positions are duration weighted.

32. The computer implemented method of claim 16 wherein the second reference position is equal but opposite in magnitude to the first reference position with respect to price sensitivity to changes in an exchange rate.

33. The computer implemented method of claim 30 wherein the first and second reference positions are currency weighted.

34. The computer implemented method of claim 16 further comprising requiring, by the processor, maintenance, by the user, of a performance bond to cover risk of loss of the fixed income instrument yield spread irrespective of the first and second reference positions.

35. A computer implemented system for determining a final settlement price of a futures contract the underlier of which is a reference spread between a first reference position in a first set of fixed income instruments and a second reference position in a second set of fixed income instruments, the second reference position being equal but opposite in magnitude to the first reference position, the reference spread being characterized by a magnitude specified as a number of incremental units between a representative yield to maturity of the first set of fixed income instruments and a representative yield to maturity of the second set of fixed income instrument, the contract further defining a fixed value of each incremental unit, the system comprising a processor and a memory coupled therewith, the system further comprising:
first logic stored in the memory and executable by the processor to compute a first representative yield to maturity of a first subset of the first set of fixed income instruments, each fixed income instrument of the first subset being characterized by a maturity date occurring witching a first date range, the influence on the first representative yield to maturity of those fixed income instruments of the first subset characterized as having an outlier yield to maturity being minimized thereby;
second logic stored in the memory and executable by the processor to compute a second representative yield to maturity of a second subset of the second set of fixed income instruments, each fixed income instrument of the second subset being characterized by a maturity date occurring within a second date range, the influence on the second representative yield to maturity of those fixed income instruments of the second plurality characterized as having an outlier yield to maturity being minimized thereby; and
third logic stored in the memory and coupled with the first and second logic and executable by the processor to compute the final settlement price as the difference between the first and second representative yields to maturity, irrespective of the quantity of first and second fixed income instruments in the first and second sets needed for the first and second reference positions respectively, to maintain the fixed value of each incremental unit of the reference spread.

36. The computer implemented system of claim 35 wherein the first reference position comprises a notional long position in the first set of fixed income instruments and the second reference position comprises a notional short position in the second set of fixed income instruments.

37. The computer implemented system of claim 35 wherein the first logic is further executable by the processor to compute the first representative yield to maturity as a median yield to maturity of the first subset, and the second logic is further executable by the processor to compute the second representative yield to maturity as a median yield to maturity of the second subset.

38. The computer implemented system of the claim 35 wherein the first and second date ranges comprise maturity dates between 97 and 120 months from settlement of the contract.

39. The computer implemented system of the claim 35 wherein the first and second date ranges comprise maturity dates occurring with a 13 month interval centered on an expiration date of the contract.

40. The computer implemented system of claim 35 wherein the incremental unit is one basis point equivalent to 100 currency units.

41. The computer implemented system of claim 35 wherein each of the first set of fixed income instruments comprise a bond issued by a first sovereignty and characterized by a maturity and each of the second set of fixed income instruments comprise a bond issued by a second sovereignty different from the first sovereignty and characterized by the maturity.

42. The computer implemented system of claim 41 wherein the maturity is one of 2 year or 10 year.

43. The computer implemented system of claim 35 wherein each of the first set of fixed income instruments comprise a mortgage backed security and each of the second set of fixed income instruments comprise a treasury bond.

44. The computer implemented system of claim 35 wherein each of the first set of fixed income instruments comprise a long term conventional treasury bond and each of the second set of fixed income instruments comprise a treasury inflation protected bond.

45. The computer implemented system of claim 35 wherein the price of the contract was previously computed based on the difference between the expected yield at maturity of the first set of fixed instruments and the expected yield at maturity of the second set of fixed instruments.

46. The computer implemented system of claim 35 wherein the second reference position is equal but opposite in magnitude to the first reference position with respect to price sensitivity to changes in interest rate.

47. The computer implemented system of claim 46 wherein the first and second reference positions are duration weighted.

48. The computer implemented system of claim 35 wherein the second reference position is equal but opposite in magnitude to the first reference position with respect to price sensitivity to changes in an exchange rate.

49. The computer implemented system of claim 48 wherein the first and second reference positions are currency weighted.

50. A computer implemented system for maintaining a fixed income instrument yield spread in balance as market conditions change until an occurrence of a terminating event, the system comprising:
a receiver operative to receive, from a user via first interface coupled with the receiver, a defined pecuniary value of one basis point of a reference yield spread between representative yields of a first reference position in a set of first fixed income instruments and a second reference position in a set of second fixed income instruments of equal but opposite magnitude to the first reference position;
the receiver being further operative to receive, via a second interface coupled with the receiver, data representative of market conditions for the first and second fixed income instruments; and
a processor coupled with the receiver and operative to maintain, automatically, the defined pecuniary value by allowing quantities of the first and second fixed income instruments of the first and second sets to fluctuate as the market conditions change; and
wherein the quantities of the first and second sets are determined by the processor upon the occurrence of the terminating event by determining, for a first subset of the first set of fixed income instruments, each fixed income instrument of the first subset being characterized by a maturity date occurring within a first date range and a yield to maturity, and a second subset of the second set of fixed income instruments, each fixed income instrument of the second subset being characterized by a maturity date occurring within second date range and a yield to maturity, a first representative yield to maturity of the first subset and a second representative yield to maturity of the second subset and deterring a value of the reference yield spread based on a difference between the first and second representative yields to maturity.

51. The system of claim 50 wherein the first reference position comprises a notional long position in the first set of fixed income instruments and the second reference position comprises a notional short position in the second set of fixed income instruments.

52. The system of claim 50 wherein the pecuniary value of one basis point is defined as 100 currency units.

53. The system of the claim 50 wherein the first and second date ranges comprise maturity dates between 97 and 120 months from settlement of the contract.

54. The system of the claim 50 wherein the first and second date ranges comprise maturity dates occurring with a 13 month interval centered on an expiration date of the contract.

55. The system of claim 50 wherein the processor is further operative to determine the first and second representative yields to maturity such that influence of those fixed value instruments of the respective first and second subsets of fixed income instruments having outlier yields to maturity is minimized.

56. The system of claim 50 wherein the first representative yield to maturity comprises a median yield to maturity of the first subset of fixed income instruments and the second representative yield to maturity comprises a median yield to maturity of the second subset of fixed income instruments.

57. The system of claim 50 wherein each of the first set of fixed income instruments comprise a bond issued by a first sovereignty and characterized by a maturity and each of the second set of fixed income instruments comprise a bond issued by a second sovereignty different from the first sovereignty and characterized by the maturity.

58. The system of claim 57 wherein the maturity is one of 2 year or 10 year.

59. The system of claim 50 wherein each of the first set of fixed income instruments comprise a mortgage backed security and each of the second set plurality of fixed income instruments comprise a treasury bond.

60. The system of claim 50 wherein each of the first set of fixed income instruments comprise a long term conventional treasury bond and each of the second set of fixed income instruments comprise a treasury inflation protected bond.

61. The system of claim 50 wherein changes in the market conditions comprises changes in an interest rate.

62. The system of claim 50 wherein the processor is further operative to maintain the defined pecuniary value by compensating, automatically by the processor, for dislocations in interest rate sensitivity between the first and second reference positions.

63. The system of claim 50 wherein the first position is characterized by a first currency unit and the second position is characterized by a second currency unit different from the first currency unit, the processor being further operative to maintain the defined pecuniary value by compensating, automatically by the processor, for fluctuations in an exchange rate between the first and second currency units.

64. The system method of claim 50 wherein the second reference position is equal but opposite in magnitude to the first reference position with respect to price sensitivity to changes in interest rate.

65. The system of claim 64 wherein the first and second reference positions are duration weighted.

66. The system of claim 50 wherein the second reference position is equal but opposite in magnitude to the first reference position with respect to price sensitivity to changes in an exchange rate.

67. The system of claim 66 wherein the first and second reference positions are currency weighted.

68. The system of claim 50 further comprising requiring, by the processor, maintenance, by the user, of a performance bond to cover risk of loss of the fixed income instrument yield spread irrespective of the first and second reference positions.
